(19) United States
(12) Patent Application Publication
(10) Pub. No.: US 2025/0206179 A1
(43) Pub. Date: Jun. 26, 2025

(54) SMART PREDICTIVE BATTERY DOCK AND SWAP MODULE TO RECHARGE A COMMERCIAL VEHICLE WHEN THE COMMERCIAL VEHICLE IS IN MOTION

(71) Applicant: Volvo Truck Corporation, GÖTEBORG (SE)

(72) Inventors: Nagdev SUDHARSAN, Chennai (IN); Vinayak ANTIN, Bangalore (IN)

(21) Appl. No.: 18/848,730

(22) PCT Filed: Apr. 14, 2022
(86) PCT No.: PCT/IB2022/053543

§ 371 Date: Sep. 19, 2024

(51) Int. Cl. B60L 53/68; B60L 53/57; B60L 53/80; B60L 58/14; G06Q 10/1093

(52) U.S. Cl. CPC B60L 53/68; B60L 53/57; B60L 53/80; B60L 58/14; G06Q 10/1095; B60L 2240/72; B60L 2250/12

(57) ABSTRACT

A method for extending a range of a commercial vehicle having a traction battery, the method includes predicting a remaining range of the commercial vehicle in real-time. The method includes determining, based on the remaining range, whether the commercial vehicle should engage with one of a smart battery dock or a traction battery swap module based on the remaining range and availability of the smart battery dock and of the traction battery swap module. The method includes scheduling, according to the remaining range and based on the availability of the smart battery dock and the traction battery swap module, a rendezvous of the commercial vehicle with one of the smart battery dock to be towed by the commercial vehicle to charge the traction battery while the commercial vehicle is in motion or the traction battery swap module to swap the traction batteries with other traction batteries.

### TECHNICAL FIELD

The present disclosure is related to charging systems for electric commercial vehicles, and more particularly, to a system for providing an electric commercial vehicle a charging system for providing charging services to commercial vehicles while the commercial vehicles are in motion.

### BACKGROUND

Driving range of electric commercial vehicles, time to recharge batteries in the commercial vehicles, and lack of electric commercial vehicle charging infrastructure are of great concern to eliminate unplanned stops of battery operated commercial vehicles on the road.

Currently, there are stationary battery charging facilities and hubs where the commercial vehicles must stop and charge the batteries of the commercial vehicle. There is however a limited number of charging stations available and poorly planned state of charge management of the vehicle's electrical storage system may therefore result in depleted batteries at undesirable locations.

### SUMMARY

According to some embodiments, method for extending a range of a commercial vehicle having a traction battery includes predicting a remaining range of the commercial vehicle in real-time. The method includes determining, based on the remaining range, whether the commercial vehicle should engage with one of a smart battery dock or a traction battery swap module based on the remaining range and availability of the smart battery dock and availability of the traction battery swap module. The method includes scheduling, according to the remaining range and based on the availability of the smart battery dock and availability of the traction battery swap module, a rendezvous of the commercial vehicle with one of the smart battery dock to be towed by the commercial vehicle to charge the traction batteries while the commercial vehicle is in motion or the traction battery swap module to swap the traction batteries with other traction batteries.

Advantages that may be achieved by the various embodiments include minimizing vehicle idle time to recharge battery in parked mode at a battery charging station and providing an option to swap the currently used and nearly discharged traction batteries to new charged traction batteries from the traction battery swap module.

According to other embodiments, a computer program product including a non-transitory storage medium includes program code to be executed by processing circuitry of a computing device, whereby execution of the program code causes the computing device to perform operations including predicting a remaining range of the commercial vehicle in real-time. The operations include determining, based on the remaining range, whether the commercial vehicle should engage with one of a smart battery dock or a traction battery swap module based on the remaining range and availability of the smart battery dock and availability of the traction battery swap module. The operations include scheduling, according to the remaining range and based on the availability of the smart battery dock and availability of the traction battery swap module, a rendezvous of the commercial vehicle with one of the smart battery dock to be towed by the commercial vehicle to charge the traction batteries while the commercial vehicle is in motion or the traction battery swap module to swap the traction batteries with other traction batteries.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic side view of a commercial truck having traction batteries within a battery compartment of the commercial truck;

FIG. 2 is a block diagram of a computing device in accordance with some embodiments;

FIG. 3 is a schematic side view of the commercial truck of FIG. 1 hooked up to a trailer having a hitch receptacle according to some embodiments;

FIG. 4 is a flow chart illustrating operations that a computing device of the commercial truck performs according to some embodiments;

FIG. 5 is a schematic side view of a smart battery dock according to some embodiments;

FIG. 6 is a schematic side view of a smart battery dock being hitched to the trailer according to some embodiments;

FIG. 7 is a schematic side view of battery charge cables connected to a charge port located on a rear of a commercial vehicle according to some embodiments;

FIG. 8 is a schematic side view of a battery charge port according to some embodiments;

FIGS. 9A and 9B are a schematic side view of a commercial vehicle having a battery compartment according to some embodiments; and

FIGS. 10-11 are flow charts illustrating operations that a computing device of the commercial truck performs according to some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As used herein, a “smart battery dock” is a dockable trailer having charging components that can be hitched to a commercial truck or trailer of a commercial truck and charge the traction batteries of the commercial truck while the commercial truck is traveling on its route. For example, the dockable trailer may have a bank of batteries that can be converted to an alternating current (ac) voltage that is transmitted to the commercial vehicle and converted to a charging voltage at the commercial vehicle. This allows the smart battery dock 500 to charge traction batteries having different voltages. In other embodiments, the output voltage of the bank of batteries and supplied directly to the commercial vehicle without any conversion at the commercial vehicle is converted to the voltage required at the smart battery dock and supplied to the commercial vehicle.

A “traction battery swap module” is a module having charged traction batteries that are used to replace the traction batteries the commercial vehicle is presently using to operate the commercial vehicle. The traction battery swap module is generally located at the same location as smart battery docks. When the traction battery swap module is used, trained personnel remove the currently used traction batteries and replace the currently used traction batteries with new traction batteries.

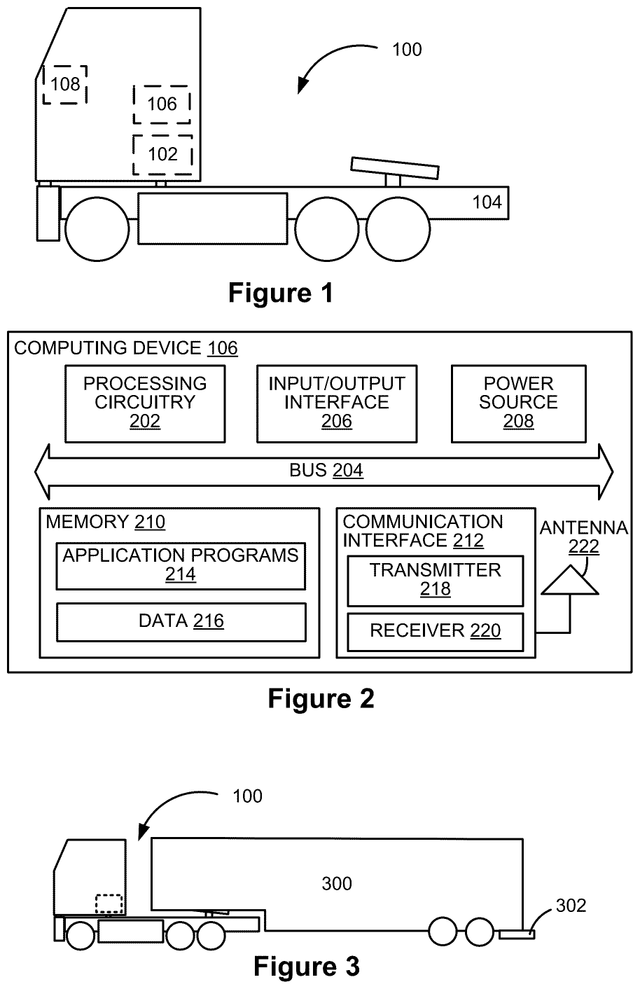

FIG. 1 shows a commercial truck 100 with traction batteries 102 within a battery compartment (not shown). The traction batteries 102 may also be mounted in other locations such as the rear end of the frame chassis 104. A computing device 106 monitors the traction batteries and communicates with an operator of the commercial truck via instrument panel 108.

FIG. 2 shows a computing device 106 in accordance with some embodiments.

As used herein, a computing device refers to a device capable, configured, arranged and/or operable to communicate wirelessly with network nodes and/or other computing devices. Examples of a computing device include, but are not limited to, wireless customer-premise equipment (CPE), vehicle-mounted or vehicle embedded/integrated wireless device, etc. The computing device 106 may be integrated with the commercial vehicle's control module (not shown).

A computing device 106 may support device-to-device (D2D) communication, for example by implementing a standard for sidelink communication, Dedicated Short-Range Communication (DSRC), vehicle-to-vehicle (V2V), vehicle-to-infrastructure (V2I), or vehicle-to-everything (V2X).

The computing device 106 includes processing circuitry 202 that is operatively coupled via a bus 204 to an input/output interface 206, a power source 208, a memory 210, a communication interface 212, and/or any other component, or any combination thereof. Certain computing devices may utilize all or a subset of the components shown in FIG. 2. The level of integration between the components may vary from one computing device to another computing device.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the computing device 106 via input circuitry or an interface such as an electrical power cable.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the computing device 106, any of a variety of various operating systems or combinations of operating systems.

The memory 210 may allow the computing device 106 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another computing device or a network node in an access network). Each transceiver may include a transmitter 218 and/or a receiver 220 appropriate to provide network communications (e.g., optical, electrical, frequency allocations, and so forth).

Regardless of the type of sensor, a computing device 106 may provide an output of data captured by its sensors, through its communication interface 212, via a wireless connection to a network node. The output may be periodic (e.g., once every 10 minutes if it reports the sensed temperature), random (e.g., to even out the load from reporting from several sensors), in response to a triggering event (e.g., when excessive battery draining of batteries 102 is detected, an alert is sent), in response to a request (e.g., a commercial vehicle operator initiated request), or a continuous stream.

As shown in FIG. 3, the commercial truck during operation is hauling goods loaded into a trailer 300 having a hitch receptacle 302. Other trailers can be connected to trailer 300 via hitch receptacle 302 and a wiring harness (not shown).

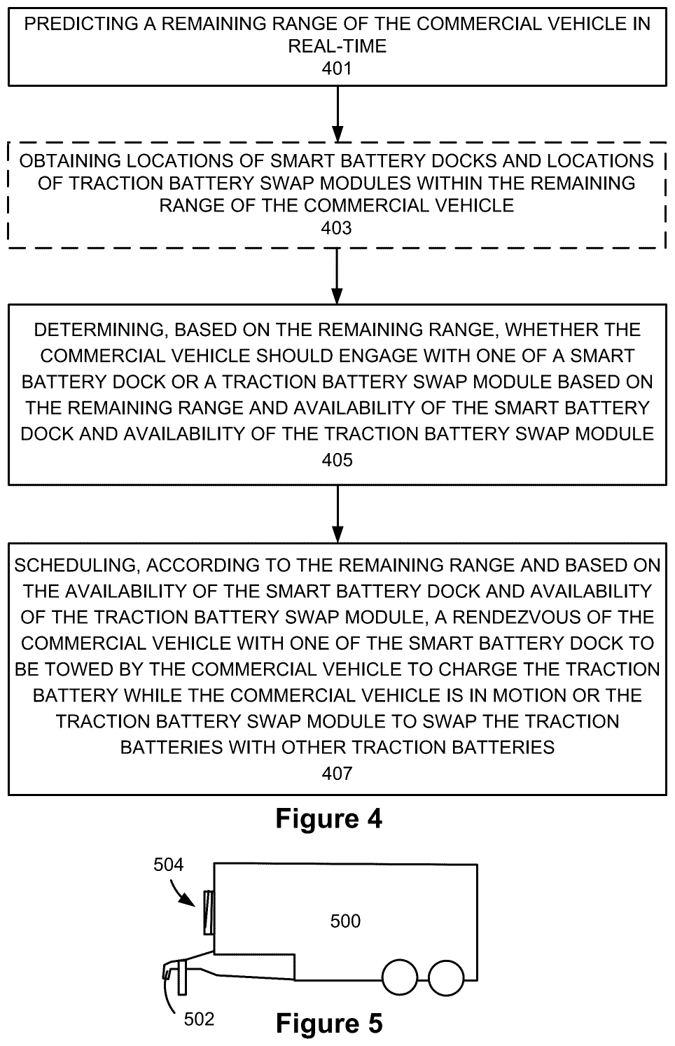

FIG. 4 illustrates operations the computing device 106 performs while the commercial truck 100 is operating to provide charging services to the commercial vehicle while the commercial vehicle is in motion using smart battery docks or traction battery swap modules.

In block 401, the computing device 106 predicts a remaining range of the commercial vehicle in real-time. In other words, the computing 106 predicts how far the commercial vehicle can travel before the commercial vehicle's traction batteries need to be charged or replaced.

In some embodiments, the computing device 106 predicts a remaining range of the commercial vehicle by predicting when a charge of the traction battery will be at a low battery threshold. The computing device 106 may predict when a charge of the traction battery will be at a low battery threshold by determining a battery charge draining rate based on the load of the commercial vehicle, a speed of the commercial vehicle, environmental conditions of a route of the commercial vehicle, and topography of the route. For example, a heavy load of the commercial vehicle 100 will drain the traction battery 102 at a faster rate than a light load of the commercial vehicle 100. Environmental conditions such as high temperatures or extreme cold temperatures also affect the draining rate. A commercial vehicle traveling primarily uphill will have a higher draining rate than a vehicle traveling primarily downhill or across generally flat land.

In some embodiments, the computing device 106 may provide a warning to the operator of the commercial vehicle 100 via display 108 to adjust speed to decrease battery charge draining rate. In other embodiments, the computing device 106 may provide a suggestion to the operator of the commercial vehicle of a recommended gear to use to decrease or maintain the battery charge draining rate.

In block 403, the computing device 106 obtains locations of smart battery docks and locations of traction battery swap modules within the remaining range of the commercial vehicle. For example, the computing device 106 may access a local database that may be periodically updated to obtain the locations of smart battery docks. In other embodiments, the computing device 106 may access an external database via communication interface 212 and antenna 222. The external database may be fleet specific for those scenarios where the commercial vehicle is part of a fleet of commercial vehicles. In other scenarios, the operator of the commercial truck 100 may subscribe to an external database that provides the commercial vehicle locations of smart battery docks and locations of battery swap modules. In some embodiments, the computing device 106 is configured with locations of smart battery docks and locations of traction battery swap modules. In other embodiments, the computing device 106 obtains the travel route of the commercial vehicle 100 and obtains the locations of smart battery docks and locations of traction battery swap modules prior to the commercial vehicle 100 starting to travel along the route. In these other embodiments, block 403 is not performed during travel along the route.

The commercial vehicle's traction battery may be charged while the commercial vehicle is traveling to its destination using the smart battery dock.

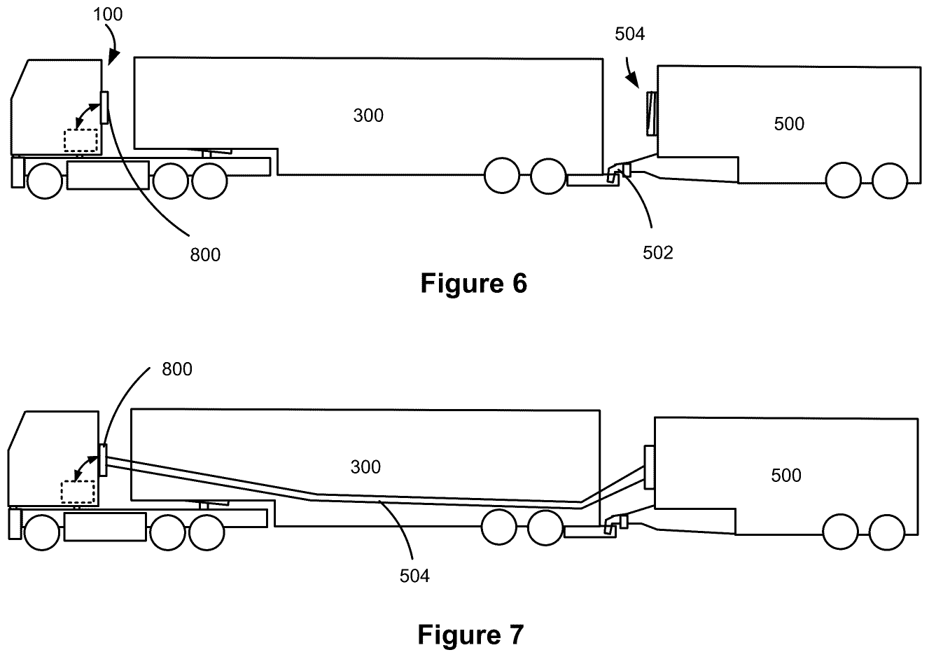

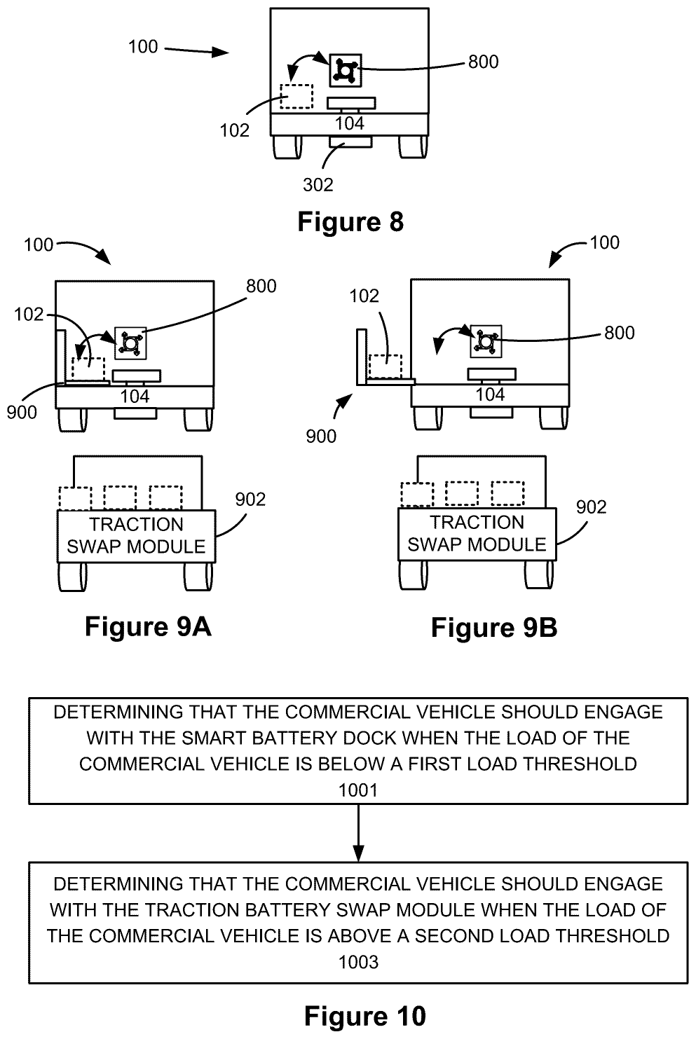

FIG. 5 illustrates an example of a smart battery dock 500. The smart battery dock 500 has a hitch 502 for hitching to the hitch receptacle of the trailer 300. This is illustrated in FIG. 6. Once the smart battery dock 500 is hitched to trailer 300, the battery charge cables 504 are routed along the trailer 300 as illustrated in FIG. 7 and connected to a battery charge port 800 (see FIG. 8). Once connected to the battery charge port, the smart battery dock 500 can start charging the traction batteries 102. While the battery charge cables 504 are shown as mounted external to the smart battery dock 500, in other embodiments, the battery charge cables 504 are stored inside of the smart battery dock 500. During operation, the smart battery dock charges the traction batteries 106 while the commercial vehicle is in motion.

Turning to FIG. 8, the operator of the commercial vehicle 100 may have to add the charge port 800 at a rear chassis cross member of the commercial vehicle 100 along with a wiring harness to enable the battery charge cables to be plugged into the rear of the commercial vehicle to charge the traction batteries 102 when the commercial vehicle 100 is in motion.

In other embodiments, the commercial vehicle's traction batteries may be replaced as described herein. FIGS. 9A and 9B illustrates an embodiment of replacing the traction batteries 102. Turning to FIG. 9A, the battery compartment 900 is shown in a closed position. FIG. 9B illustrates the battery compartment 900 in an open position. When the battery compartment 900 is in an open position, the traction batteries 102 are disconnected from the commercial vehicle's wiring harness(es) and are replaced with new traction batteries 102 from the traction swap module 902. The new traction batteries are then connected to the wiring harness(es) and the battery compartment 900 is closed. When the traction battery swap module 902 is engaged, the computing device 106 will, prior to opening the battery compartment 900, prepare the commercial vehicle 100 by setting the commercial vehicle 100 into a hibernation mode and disconnecting from battery sensors.

Returning to FIG. 4, in block 405, the computing device 106 determines, based on the remaining range, whether the commercial vehicle should engage with one of a smart battery dock 500 or a traction battery swap module 902 based on the remaining range and availability of the smart battery dock 500 and availability of the traction battery swap module 902. In some embodiments, the determination is further based on a load of the commercial vehicle and environmental conditions.

FIG. 10 illustrates an embodiment of determining whether the commercial vehicle should engage with one of a smart battery dock or a traction battery swap module. Turning to FIG. 10, in block 1010, the computing device 106 determines that the commercial vehicle should engage with the smart battery dock 500 when the load of the commercial vehicle 106 is below a first load threshold. In block 1003, the computing device 106 determines that the commercial vehicle should engage with the traction battery swap module 902 when the load of the commercial vehicle 106 is above a second load threshold. In some embodiments, the first load threshold and the second load threshold are the same threshold.

In other embodiments, the first load threshold and the second load threshold are different thresholds. In these embodiments, the preferences of the operator of the commercial vehicle can be used to determine which of the traction battery swap module 902 or smart battery dock 500 should be used. In situations where the commercial vehicle is part of a fleet, fleet preferences can be used to determine which of the traction battery swap module 902 or smart battery dock 500 should be used.

Returning to FIG. 4, in block 407, the computing device 106 schedules, according to the remaining range and based on the availability of the smart battery dock 500 and availability of the traction battery swap module, a rendezvous of the commercial vehicle 106 with one of the smart battery dock 500 to be towed by the commercial vehicle to charge the traction batteries while the commercial vehicle is in motion or the traction battery swap module to swap the traction batteries with other traction batteries.

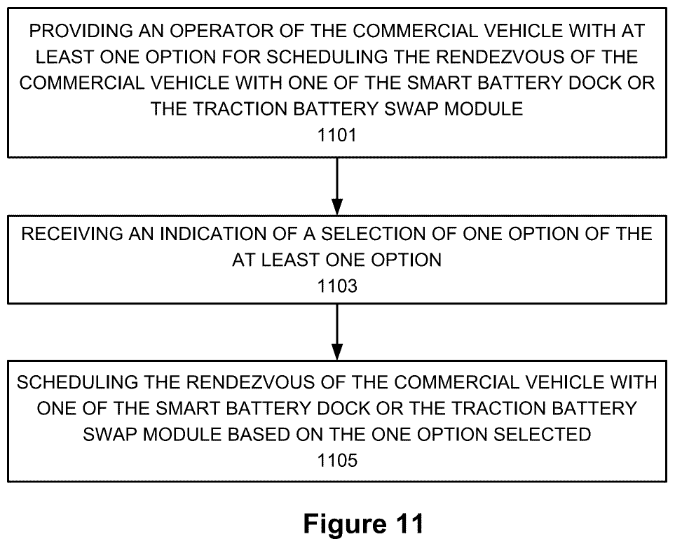

In some embodiments, the scheduling is further based on preferences of the operator of the commercial vehicle 100. This is illustrated in FIG. 11.

Turning to FIG. 11, in block 1101, the computing device 106 provides an operator of the commercial vehicle 100 with at least one option for scheduling the rendezvous of the commercial vehicle with one of the smart battery dock or the traction battery swap module. For example, if only one of the smart battery dock or the traction battery is available, then the operator can only select the one of the smart battery dock or the traction battery that is available.

In block 1103, the computing device 106 receives an indication of a selection of one option of the at least one option. For example, if there are more than one option available, the operator selects one of the options and the computing device receives an indication of which option is selected. One scenario where this can occur is when there are smarty battery docks available at different locations and traction battery swap modules at different locations. The operator of the commercial vehicle 100 may prefer one location over another location and select the option at the preferred location. Once that option is selected, the computing device 106 receives an indication of the one option that is selected. The indication may identify the location and whether a smart battery dock 500 or traction battery swap module 902 was chosen.

In block 1105, the computing device 106 schedules the rendezvous of the commercial vehicle with one of the smart battery dock or the traction battery swap module based on the one option selected. For example, the computing device 106 may transmit a scheduling request to the scheduler person or device for the smart battery dock 500 or the traction battery swap module 902.

The commercial vehicle 100 travels to the location of the smart battery dock 100 if the smart battery dock is scheduled or the location of the traction battery swap module 902 if the traction battery swap module 902 has been scheduled.

An example of the above is a commercial vehicle 100 traveling from Greensboro, North Carolina to New York. The computing device 106 determines that based on the remaining range of the commercial vehicle 100, the commercial vehicle 100 will have to schedule either a traction battery swap module or a smart battery dock in the vicinity of Washington, DC. The computing device obtains locations of traction battery swap modules 902 and locations of smart battery docks 500 in the vicinity of Washington, DC. Based on the availability, load conditions, environmental factors, etc. as described above, the computing device provides the operator of the commercial vehicle 100 options, receives a selection, and schedules either the smart battery dock or the traction battery swap module based on the selection. The commercial vehicle stops to hitch the smart battery dock 500 and connect the battery charging cable as described above or swaps the traction batteries as described above and continues on to New York.

As can be seen, the various embodiments described herein minimizes vehicle idle time to recharge battery in parked mode at a battery charging station and provides an additional option to swap the currently used nearly discharged traction batteries to new charged traction batteries from the traction battery swap module.

1. A method for extending a range of a commercial vehicle having a traction battery, the method comprising:
predicting a remaining range of the commercial vehicle in real-time;
determining, based on the remaining range, whether the commercial vehicle should engage with one of a smart battery dock or a traction battery swap module based on the remaining range and availability of the smart battery dock and availability of the traction battery swap module; and
scheduling, according to the remaining range and based on the availability of the smart battery dock and availability of the traction battery swap module, a rendezvous of the commercial vehicle with one of the smart battery dock to be towed by the commercial vehicle to charge the traction battery while the commercial vehicle is in motion or the traction battery swap module to swap the traction batteries with other traction batteries.

2. The method of claim 1, further comprising:
obtaining locations of smart battery docks and locations of traction battery swap modules within the remaining range of the commercial vehicle.

3. The method of claim 1, wherein scheduling the rendezvous of the commercial vehicle with one of the smart battery dock or the traction battery swap is further based on preferences of an operator of the commercial vehicle.

4. The method of claim 1, wherein determining whether the commercial vehicle should engage with one of a smart battery dock or a traction battery swap module is further based on a load of the commercial vehicle and environmental conditions.

5. The method of claim 4, determining whether the commercial vehicle should engage with one of a smart battery dock or a traction battery swap module comprises:
determining that the commercial vehicle should engage with the smart battery dock when the load of the commercial vehicle is below a first load threshold; and
determining that the commercial vehicle should engage with the traction batter swap module when the load of the commercial vehicle is above a second load threshold.

6. The method of claim 5, wherein the first load threshold and the second load threshold are the same threshold.

7. The method of claim 1, wherein predicting a remaining range of the commercial vehicle in real-time comprises predicting when a charge of the traction battery will be at a low battery threshold.

8. The method of claim 7 wherein predicting when a charge of the traction battery will be at a low battery threshold comprises determining a battery charge draining rate based on the load of the commercial vehicle, a speed of the commercial vehicle, environmental conditions of a route of the commercial vehicle, and topography of the route.

9. The method of claim 8, further comprising providing a warning to the operator of the commercial vehicle to adjust speed to decrease the battery charge draining rate.

10. The method of claim 8, further comprising providing a suggestion to the operator of the commercial vehicle of a recommended gear to use to decrease or maintain the battery charge draining rate.

11. The method of claim 1, wherein scheduling,
according to the remaining range and based on the availability of the smart battery dock and availability of the traction battery swap module, a rendezvous of the commercial vehicle with one of the smart battery dock or the traction battery swap module comprises:
providing an operator of the commercial vehicle with at least one option for scheduling the rendezvous of the commercial vehicle with one of the smart battery dock or the traction battery swap module;
receiving an indication of a selection of one option of the at least one option; and
scheduling the rendezvous of the commercial vehicle with one of the smart battery dock or the traction battery swap module based on the one option selected.

12. A computer program product comprising a non-transitory storage medium including program code to be executed by processing circuitry of a computing device, whereby execution of the program code causes the computing device to perform operations comprising:
predicting a remaining range of the commercial vehicle in real-time;
determining, based on the remaining range, whether the commercial vehicle should engage with one of a smart battery dock or a traction battery swap module based on the remaining range and availability of the smart battery dock and availability of the traction battery swap module;
scheduling, according to the remaining range and based on the availability of the smart battery dock and availability of the traction battery swap module, a rendezvous of the commercial vehicle with one of the smart battery dock to be towed by the commercial vehicle to charge the traction battery while the commercial vehicle is in motion or the traction battery swap module to swap the traction batteries with other traction batteries.

13. The computer program product of claim 12, wherein the non-transitory storage medium includes further program code to perform further operations comprising:
obtaining locations of smart battery docks and locations of traction battery swap modules within the remaining range of the commercial vehicle.

14. The computer program product of claim 12, wherein scheduling the rendezvous of the commercial vehicle with one of the smart battery dock or the traction battery swap is further based on preferences of an operator of the commercial vehicle.

15. The computer program product of claim 12, wherein determining whether the commercial vehicle should engage with one of a smart battery dock or a traction battery swap module is further based on a load of the commercial vehicle and environmental conditions.

16. The computer program product of claim 15, determining whether the commercial vehicle should engage with one of a smart battery dock or a traction battery swap module comprises:
determining that the commercial vehicle should engage with the smart battery dock when the load of the commercial vehicle is below a first load threshold; and
determining that the commercial vehicle should engage with the traction battery swap module when the load of the commercial vehicle is above a second load threshold.

17. The computer program product of claim 12, wherein predicting a remaining range of the commercial vehicle in real-time comprises predicting when a charge of the traction battery will be at a low battery threshold.

18. The computer program product of claim 17 wherein predicting when a charge of the traction battery will be at a low battery threshold comprises determining a battery charge draining rate based on the load of the commercial vehicle, a speed of the commercial vehicle, environmental conditions of a route of the commercial vehicle, and topography of the route.

19. The computer program product of claim 18, further comprising providing a warning to the operator of the commercial vehicle to adjust speed to decrease the battery charge draining rate.

20. The computer program product of claim 12, wherein scheduling, according to the remaining range and based on the availability of the smart battery dock and availability of the traction battery swap module, a rendezvous of the commercial vehicle with one of the smart battery dock or the traction battery swap module comprises:
providing an operator of the commercial vehicle with at least one option for scheduling the rendezvous of the commercial vehicle with one of the smart battery dock or the traction battery swap module;
receiving an indication of a selection of one option of the at least one option; and
scheduling the rendezvous of the commercial vehicle with one of the smart battery dock or the traction battery swap module based on the one option selected.
